(19) United States
(12) Patent Application Publication
(10) Pub. No.: US 2017/0073780 A1
(43) Pub. Date: Mar. 16, 2017

(54) SYSTEMS AND METHODS FOR RECONDITIONING LEATHER

(71) Applicant: BRENT BLACK, ROUND ROCK, TX (US)

(72) Inventor: BRENT BLACK, ROUND ROCK, TX (US)

(21) Appl. No.: 15/267,724

(22) Filed: Sep. 16, 2016

Related U.S. Application Data
(60) Provisional application No. 62/219,195, filed on Sep. 16, 2015.

(51) Int. Cl. C14C 11/00; C14C 99/00; C14B 17/00; B05D 3/00

(52) U.S. Cl. CPC C14C 11/00; B05D 3/002; C14C 99/00; C14B 17/00

(57) ABSTRACT

A process for preserving and restoring leather upholstery through steps involving use of cleaning, dye, conditioning and sealing materials, and, prior to dying or conditioning, abrading the material, in part, for restoring access to hide pores for optimizing the hide's degree and uniformity of acceptance of dye(s) and conditioner(s).

### PRIORITY CLAIM

Applicants and inventors claim priority, pursuant to 35 U.S.C. §119(d), with respect to U.S. Provisional Patent Application No. 62/219,195, filed 16 Sep. 2015.

### BACKGROUND OF THE INVENTION

1. Field of The Invention

The present invention relates to leather treatment and refurbishing.

2. Background Information

Having leather upholstery is among the most expensive of options for home, automobile, aircraft and other seating. Leather is also among the least understood of materials with respect to proper care, preservation and restoration.

For most upholstery materials, one can purchase a bottle or can of a substance that is applied to the upholstery for cleaning and/or providing stain resistance to the material. Instructions typically provide for some agitation of the substance after application, and later removal by wiping or vacuum of some kind. Unfortunately, leather cleaning and preservation, and much less restoration is achievable in this manner. Many Products that are suitable for fibrous or synthetic leather materials are at best ineffective, and often worse are destructive to authentic leather.

Particularly in the high-end automobile and aircraft industries, visibly worn leather upholstery is often replaced at many thousands of dollars of expense. Even in the high-end automobile realm, vehicles are even prematurely retired (traded in or otherwise sold) simply because the appearance of the vehicle is not to the standards of its owner because of Warren Al” leather seating.

While the use of currently available “leather creams” and the like may prolong the useful life of leather upholstery, conventional use of such products do virtually nothing to restore previously neglected leather upholstery, nor to the fullest extent possible through application of the hereafter described processes, extend leather upholstery life anywhere near its potential. Further still, when re-dying of the previously died and extensively used leather materials is involved, currently practiced methods produce aesthetically unacceptable results (uneven, or “splotchy” tint and contrast).

### SUMMARY OF THE INVENTION

In view of the foregoing, the present inventor here discloses and claims an improved leather treatment process for preserving and restoring previously used and degraded leather materials.

Application of the herein described process results in leather surfaces that are of a texture, suppleness, and (when died) coloration that more resembles new leather material than is achievable through use of any presently practiced processes or methods.

### BRIEF DESCRIPTION OF THE DRAWINGS

This patent application and resulting patent includes no drawings, as such are not needed to satisfy enablement requirements.

### DETAILED DESCRIPTION OF THE PREFERRED EMBODIMENT

As mentioned previously, the process described herein is principally intended for use with previously used and degraded leather materials, but can be used periodically to preserve them from further such degradation.

The present process involves several steps that will be outlined below.

Step 1 (Leather cleaning): A user first cleans the leather (to the extent possible) of any dirt, sweat, body oil (proteins) or any other contaminates. This may be accomplished through use of a commercially available, all-purpose degreaser; mild dish soap and warm water, denatured alcohol, rubbing alcohol, mineral spirits, citrus cleaner, tri-prep cleaner, or any form of leather cleaner.

One should not over-saturate the leather with the chosen cleaner or cleaner/water mixture. Further, if more than one cleaning step is needed, one should allow the leather to dry between cleaning steps, as the removal (or not) of soiling will not (for most leather materials) be readily apparent until or unless the leather has dried.

In the one or more cleaning steps, cleaning solutions should be applied using such as a lint-free or microfiber towel, sponge(s), or a soft-bristled brush. The cleaning solutions should be applied to the entire area to be restored, in a circular motion to ensure the area is cleaned thoroughly and evenly.

Step 2 (Leather Preparation): Preparing leather for restoration involves abrading the leather. The necessity of this step relates to certain characteristics of leather that distinguish it from other, non-hide-based cover materials—that of having natural pores through which restorative substantives and dies must pass for an optimally successful restoration. Over the course of use, these pores are distorted and most often occluded through blockage or distortion. The abrading restores access to pore lumens as is needed, again, for an optimal restoration of degraded leather, or even of leather that, though not materially degraded, is to be dyed, or re-dyed.

The abrading steps involves the use of sandpaper with grit ranging from 80 to 3000. One can also use scouring pads, such as SCOTCH BRITE® brand pads.

One can hand-sand the leather, or use such as a random orbital sander. In either case, this abrading step should proceed no further than to provide a uniform exposure to the “raw” leather beneath the original patina of the material. Excessive abrading may breach the fabric entirely, and/or create unnecessarily thin areas that are prone to ripping upon later use.

If, in order to achieve the just-described state (such as when the leather is excessively cracked, deeply stained, or for some other reason) one initially uses a lower grit, more abrasive sand paper), one should later use one or a more progressively higher grit sand papers to achieve a tactilely smooth surface.

Once the preparation stage is complete, a user should wipe or vacuum the to-be-stored area to remove any dust and any other contaminants, and thereafter ensure that the surfaces are fully dry before proceeding.

Step 3 (Masking): One should next (if not already done) mask any seat piping, and plastic trim near the to-be-stored materials, principally to prevent accidental staining from the to-be-used dye.

Step 4: (Dying): After selecting and preparing a leather dye of the desired color and tint, apply the dye using the dye manufacturer's prescribed method of application. In most instances, dye may be rubbed and massaged into the leather using a lint free or microfiber towel or similar lint and remnant-free sponge or material, or may be applied through use of an automotive paint gun, air brush tool, or aerosol device.

Once again, for optimal results, one must ensure that the leather the dry between any successive applications of dye.

If, upon drying, one determines that an area did not “take” the dye to the extent of other, adjacent areas, such is usually an indication that the original patina was not adequately removed and the hide pores opened up sufficiently. Any such areas may be re-treated as in the above second step. This step can be repeated multiple times, and may also be involved in adequately remediating stains.

Step 5 (Conditioning the Leather): Once a desired color and tint is achieved through Step 4, and after ensuring that the upholstery has (once again) fully dried, one conditions the leather using a commercially available “leather dressing” or other leather-specific conditioning produce. As with other steps in the present process, it is once again recommended that one use a lint free towel, micro fiber towel, sponge or foam applicator for this step, and apply using a circular, massage-like motion. Conditioner should be applied in multiple steps (allowing to dry between each such application) until the leather material no longer perceptibly absorbs any more conditioner.

Step 6 (Sealing/Water-Proofing/Top-coating): Use of a leather-specific sealer/water proofing completes the restoration process. To avoid staining or distorting the coloring, or displacing the previously-applied conditioning substances, one should use small amounts of the sealer/water proofer at any given time, and evenly massage it into the leather. One should use the same kinds of lint-free, remnant-free application materials as described above for other steps. One may apply this last substance in several light coats, allowing the leather to fully absorb the material, and fully dry between each such application.

Following Step 6, the leather will be (to the greatest degree possible, based on its prior condition) fully restored, sealed, and water-proofed, and will provided substantially extended life, both in durability and aesthetic appearance than is achievable through any presently-employed method or process in the upholstery preservation and restoration trade.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A method for restoring previously used and degraded leather upholstery comprising the steps of:
cleaning said leather upholstery for removing foreign materials and contaminants;
abrading said leather upholstery to a degree for exposing raw leather through removal of said leather upholstery's prior patina;
substantially saturating said leather upholstery with a leather conditioner; and
applying a sealing material to said leather upholstery for substantially water-proofing said leather upholstery.
